(19) United States
(12) Patent Application Publication
(10) Pub. No.: US 2020/0388984 A1
(43) Pub. Date: Dec. 10, 2020

(54) FEMTOSECOND LASER WITH MICRO-GAIN ELEMENT AND HOLLOW CORE FIBER

(71) Applicant: Honeywell International Inc., Morris Plains, NJ (US)

(72) Inventors: Tiequn Qiu, Glendale, AZ (US); Chellappan Narayanan, Phoenix, AZ (US); Jeffrey Earl Lewis, Phoenix, AZ (US); Sorin Mosor, Peoria, AZ (US)

(73) Assignee: Honeywell International Inc., Morris Plains, NJ (US)

(21) Appl. No.: 16/435,148

(22) Filed: Jun. 7, 2019

(51) Int. Cl. H01S 3/11; H01S 3/08; H01S 3/04; H01S 3/094; H01S 3/106

(52) U.S. Cl. CPC H01S 3/1118; H01S 3/08013; H01S 3/1067; H01S 3/0405; H01S 3/094053; H01S 3/08054

(57) ABSTRACT

A micro femtosecond laser with reduced radiation and temperature sensitivity is provided. The laser includes a housing with a radiation shield. Optical components that include a micro gain element are received within the housing. An input end of a pump light delivering fiber is positioned outside the housing. An output end of the pump light delivering fiber is positioned within the housing to deliver input beams to the optical components. A light signal generating pump is used to generate the input beams that are communicated to the input end of the pump light delivering fiber. A first end of a hollow core fiber is positioned within the housing to be in optical communication with the optical components. A second end of the hollow core fiber is positioned outside the housing. A partially reflective output coupling mirror is in optical communication with the second end of the hollow core fiber.

### STATEMENT REGARDING FEDERALLY SPONSORED RESEARCH OR DEVELOPMENT

This invention was made with Government support under FA9453-17-C-0039 awarded by AFRL. The Government has certain rights in the invention.

### BACKGROUND

Optical frequency comb is a light source that contain many equally spaced frequency modes. The first stage of an all solid core fiber optical frequency combs is a mode-locked laser oscillator that generates a femtosecond pulse waveform. A mode-locked laser consists of a gain medium and a saturable absorber inside an optical cavity. The gain medium is either electrically or optically pumped to generate the initial light; the optical cavity is a linear resonator cavity (such as, for example, a Fabry-Perot resonator) formed by two mirror ends at the opposite end of the cavity or a ring resonator cavity formed by a closed circular optical path. The optical cavity can also include one or more optical fibers to increase the length of the cavity. Mode-locked lasers are the fundamental building blocks necessary for generating optical frequency combs.

Mode-locking of a laser is achieved by building a laser cavity that is low loss for intense pulses but high loss for a low-intensity continuous beam. A device that achieves this functionality and allows intense pulses to resonate in the cavity is a saturable absorber. An example of a saturable absorber is the semiconductor saturable absorber mirror (SESAM). The dispersion and gain of the cavity are parameters that are tuned to achieve mode locking. When a laser is mode-locked, it outputs a periodic pulsed waveform in the time domain, which translates to comb of frequency modes in the frequency domain. In other words, the discrete frequency modes supported by the cavity are in phase and add coherently to generate a periodic pulsed waveform. The period of the pulsed waveform in the time domain or the mode spacing between the individual frequency modes in the frequency domain is determined by the refractive index of the medium in the optical cavity and the length of the optical cavity. A stabilized optical frequency comb—frequency drift compensated using feedback servo loops—is used in high precision applications such as spectroscopy and clocks.

Unlike in well-controlled laboratory environments, mode-locked lasers, and optical frequency comb generators that utilize them, are subject to great fluctuations in radiation and temperature in outer space. Prior examples of mode-locked lasers alter fundamentally when exposed to radiation, and especially when exposed to large amounts of radiation. For example, when a mode-locked laser cavity is exposed to radiation, the refractive index of solid core optical fibers included within the mode-locked laser cavity changes, which modifies the optical length of the mode-locked laser cavity and the repetition rate of pulse waveforms generated by the mode-locked laser. Changes in the refractive index of the optical fiber can occur due to fluctuations in temperature as well, but the effect on the refractive index from temperature is much less than the effect from radiation. In outer space, the refractive index of an optical fiber can be significantly affected beyond the compensation ranges of feedback servo loops, which causes large changes in the pulse repetition frequency of the mode-locked laser over time. These changes can be large enough to jeopardize the characteristics of the mode-locked laser (for example, repetition rate), and the usefulness of the mode-locked laser and the optical frequency comb generator utilizing the mode-locked laser is diminished.

As discussed above, the first stage of an all solid core fiber optical frequency combs is a mode-locked laser oscillator that generates a femtosecond pulse waveform. The period or repetition frequency of the pulse waveform is determined by the optical path length in the cavity. A typical femtosecond fiber laser cavity using a doped optical fiber as the gain medium and a solid core fiber as dispersion control. The pulse repetition rate is given by c/2nL, where c is the velocity of light, n is the refractive index of the fiber and L is the total length of the fiber cavity. When the laser oscillator is exposed to space radiation, the refractive index, n, of both the gain and dispersion control fiber changes, resulting in a change in pulse repetition frequency. The pulse repetition frequency also changes with temperature as discussed above. In addition to repetition rate change from fiber length change, the both the gain and dispersion control fiber also experience optical losses under radiation, making the laser output power and pulse width to be reduced. To an extreme point, the laser may lose mode-locking and no more functional as a source for frequency comb generation.

### SUMMARY

The following summary is made by way of example and not by way of limitation. It is merely provided to aid the reader in understanding some of the aspects of the subject matter described. Embodiments provide a micro femtosecond laser with reduced radiation and temperature sensitivity.

In one embodiment, a micro femtosecond laser with reduced radiation and temperature sensitivity is provided. The laser includes a housing, a pair of spaced gradient index lenses, a dichroic mirror, a micro gain element, a polarizer, a semiconductor saturable absorber mirror, a pump light delivering fiber, a hollow core fiber and a partially reflective output coupling mirror. The housing includes a radiation shield and forms a stable mechanical support. The pair of spaced gradient index lenses are received within the housing. The dichroic mirror is received within the housing and is positioned between the pair of spaced gradient index lenses. The micro gain element is received within the housing and is positioned between the dichroic mirror and a first one of the gradient index lenses. The polarizer is received within the housing and is poisoned between the dichroic mirror and a second one of the gradient index lenses. The semiconductor saturable absorber mirror is also received within the housing and is positioned to reflect light beams to the second one of the gradient index lenses. The pump light delivering fiber has an input end and an output end. The input end of the pump light delivering fiber is positioned outside the housing. The output end of the pump light delivering fiber is positioned within the housing to deliver input beams to one of the gradient index lenses. The hollow core fiber has a first end and second end. The first end of the hollow core fiber is positioned within the housing to optically communicate the light beams to the first one of the gradient index lenses. The second end of the hollow core fiber is positioned outside the housing. The partially reflective output coupling mirror in optical communication with the second end of the hollow core fiber. The output coupling mirror and the saturable absorber forming, in part, a laser resonator.

In another example embodiment, a micro femtosecond laser with reduced radiation and temperature sensitivity is provided. The laser includes a housing, optical components, a pump light delivering fiber, a hollow core fiber, a partially reflective output coupling mirror and a light signal generating pump. The housing includes a radiation shield. The optical components include a micro gain element and are received within the housing. The pump light delivering fiber has an input end and an output end. The input end of the pump light delivering fiber is positioned outside the housing. The output end of the pump light delivering fiber is positioned within the housing to deliver input beams to the optical components. The light signal generating pump is used to generate the input beams that are communicated to the input end of the pump light delivering fiber. The hollow core fiber has a first end and second end. The first end of the hollow core fiber is positioned within the housing to be in optical communication with the optical components. The second end of the hollow core fiber is positioned outside the housing. The partially reflective output coupling mirror is positioned to be in optical communication with the second end of the hollow core fiber.

In yet another embodiment, a method of forming a micro femtosecond laser with reduced radiation and temperature sensitivity is provided. The method includes positioning optical components that are susceptible to radiation including a gain medium within a housing that has radiation shielding; using a hollow core fiber that is positioned partially within the housing to form a resonator cavity with the optical components and a partially reflective output coupling mirror; and using a pump light delivering fiber that is positioned partially within the housing to deliver input beams to the optical components.

### BRIEF DESCRIPTION OF THE DRAWINGS

Embodiments can be more easily understood and further advantages and uses thereof will be more readily apparent, when considered in view of the detailed description and the following figures in which:

FIG. 1 is an illustration of a femtosecond laser with a micro gain element and a hollow core fiber according to one exemplary embodiment;

FIG. 2 is a block diagram of repetition rate control system according to one exemplary embodiment;

FIG. 3 is repetition rate control flow diagram according to one exemplary embodiment; and

FIG. 4 is a laser forming diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments provide a micro femtosecond laser with reduced radiation and temperature sensitivity. To address the issue of large change in frequency and potential loss of function, embodiments reduce the radiation induced index and optical loss change in the cavity. Embodiments use a micro-gain element instead of a gain fiber, use a hollow core fiber instead of a dispersion control solid core fiber and place radiation sensitive components within a housing that includes radiation shielding. Further, the micro-gain element used in embodiments is substantially small in size compared to a doped gain fiber so that it is far less sensitive to radiation impact. For example, the micro gain element may be only a few millimeters in thickness and diameter. The size of the gain element can also be easily enclosed in a relatively small housing with radiation shielding. For example, the housing may be a few centimeters in length and a few millimeters in diameter.

The laser may also include a hollow core fiber for controlling cavity length and dispersion with better radiation tolerance. The light (or light beam(s) as generally described) in a hollow core fiber is guided mostly in air and is almost insensitive to radiation exposure. By using the micro-gain element and the hollow core fiber in a laser, the radiation sensitivity is reduced substantially over a period of time of radiation exposure. In addition, embodiments also reduced temperature sensitivity of the hollow core fiber which reduces cavity frequency temperature sensitivity significantly.

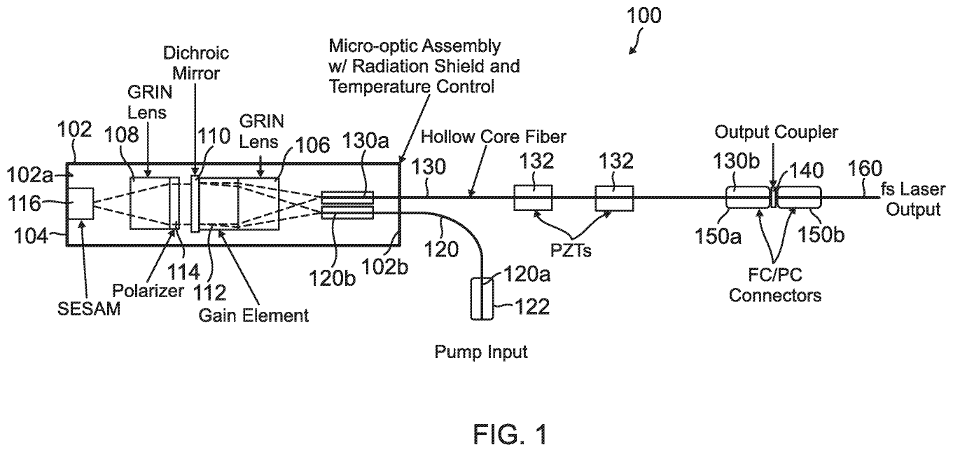

Referring to FIG. 1, an example of a micro femtosecond laser 100 of an embodiment is illustrated. This example embodiment of a laser 100 includes a housing 102. The housing 102 in an embodiment, includes a radiation shield 104 to shield radiation components that may include a gain element as well as lenses and mirrors discussed below. An example of material used to make the radiation shield is tantalum. Other types of material may be used as a radiation shield and embodiments are not limited to just using material with tantalum. Besides providing a radiation shield for the components that may be sensitive to radiation, housing 102 forms a stable mechanical support for multiple optical elements. As illustrated in FIG. 1, the housing 102 includes a first end 102a and a second end 102b.

Within the housing 102 is located a pair of spaced gradient index lenses 106 and 108 that are positioned between the first end 102a and the second end 102b of the housing. A dichroic mirror 110 is also received within the housing 102 and is positioned between the pair of spaced gradient index lenses 106 and 108. A micro gain element 112 is positioned between the dichroic mirror 110 and a first one of the gradient index lenses 106 within the housing 102. The gain element 112 may include material doped with rare earth ions such as, but not limited to, erbium, neodymium, ytterbium, thulium, praseodymium, holmium, or the like. The gain element 112, serves to amplify the light within a resonator cavity through stimulated emission. The resonator cavity in the Example embodiment extends between a semiconductor saturable absorber mirror (SESAM) 116 and an output coupling mirror 140 as discussed further below.

In the example embodiment of FIG. 1, a polarizer 114 is also received within the housing 102 and is poisoned between the dichroic mirror 110 and a second one of the gradient index lenses 108. Further, the SESAM 116 is received within the housing 102 and positioned to reflect light waves to the second one of the gradient index lenses 108. In the embodiment of FIG. 1, the SESAM 116 is positioned proximate the first end 102a of the housing 102. The SESAM 116 in an embodiment consists of a mirror structure with an incorporated saturable absorber. In some examples, the SESAM 116 consists of a Bragg mirror with a layer of semiconductor saturable film adjacent. In other examples, the SESAM 116 consists of a substrate material, with layers of dielectric film, and a semiconductor material layer. The SESAM 116 facilitates generation of ultrashort pulses for passive mode locking of the laser 100 in a mode-locked embodiment.

The laser 100 includes a pump light delivering fiber 120 that has an input end 120a and an output end 120b. The input end 120a of the pump light delivering fiber 120 is positioned outside the housing 102. The output end 120b of the pump light delivering fiber 120 is positioned within the housing 102 close to the first one of the gradient index lenses 106. In particular, the pump light delivering fiber 120 extends into the second end 102b of the housing 102 to optically deliver input beams (light signals) from pump input port 122 to the first gradient index lens 106. The beams of light coming out of the output end 120b of the fiber 120 diverge. The gradient index lens 106 is a collimating lens used to control the diameter of these diverging beams that propagate to the gain medium of the gain element 112.

The laser 100 further includes a hollow core fiber 130. The hollow core fiber 130 includes a first end 130a and second end 130b. The first end 130a of the hollow core fiber 130 extends through the second end 102b of the housing 102 and is positioned within the housing 102 close to the first gradient index lens 106. The second end 130b of the hollow core fiber 130 is positioned outside the housing 120. A partially reflective output coupling mirror 140 is positioned at the second end 130b of the hollow core fiber 140. The output coupling mirror 140 and the saturable absorber mirror 116 and hollow core fiber 140 are used to form a laser resonator cavity for the laser 100.

The second end 130b of the hollow core fiber 130 is further in optical communication with a laser output 160 in this example embodiment via a fiber optic connectors such as ferrule connector/physical contact (FC/PC) connectors 150a and 150b. An output of the laser 100 is provided by the laser output 160.

The hollow core fiber 130 in embodiments includes an optical fiber with a hollow region along the length of the fiber. Hollow core fibers operate under a different principle than those of solid core fibers. In particular, where solid core fibers rely on the higher index of refraction of the solid core to guide light, hollow core fibers rely on a mechanism called bandgap guidance where a defect (hollow core) is introduced in an opaque periodic lattice to guide light in the air region. In some examples, the hollow region of the hollow core fiber is a vacuum. In other examples the hollow region is filled with a gas (for example, air). It should be understood that a number of gases may be used depending on the desired characteristics of the hollow core fiber 130. The hollow region of the hollow core fiber 130 is surrounded by a solid micro-structured cladding material, which has a higher index of refraction than the hollow core. In some examples, the solid cladding is made from silica (for example, glass). However, it is contemplated that other mediums may be used depending on the desired properties of the hollow core fiber 130.

In some examples, the hollow core fiber 130 is configured to be a nested hollow core fiber 130 in which at least one hollow core nests within the hollow core fiber 130. In some examples, the cross-section of the nested hollow core fiber comprises a central vacant region, or core, surrounded by a series of tubes, for example, made from glass; however, it is contemplated that other materials may be used. The cross-section for such tubes can be circular, elliptical, or the like and the tubes may be filled with a vacuum or gas (for example, air).

In some examples, the hollow core fiber 130 is configured such that its total dispersion is anomalous. Thus, in some examples, the hollow core fiber 130 is configured such that the index of refraction of the hollow core fiber increases as the wavelength of the light increases. In some examples, the periodicity of the micro-structured cladding region with air holes used to guide light in a hollow core can be modified to produce anomalous dispersion.

Also included in the laser 100 are piezoelectric transducers (PZTs) 132 that are in contact with the hollow core fiber 130. In the example of FIG. 1, two PZTs 132 are used. However, any number of PZTs may be used. The PZTS 132 may be referred to as piezoelectric-based fiber stretchers and are used to selectively adjust the length of the resonator cavity. As discussed above, in the embodiment of FIG. 1, the PZTs are mechanically coupled to the hollow core fiber 130. The at least one piezoelectric transducer 132 is configured to modify the optical length of the hollow core fiber 130 in this example embodiment based on a feedback or control signal. The at least one PZT 132 is controlled to maintain a particular optical cavity length, so the repetition rate of the laser 100 (which may be a mode-locked laser) is kept constant. This provides a stable resonator cavity. An example of a desired repetition rate using the components of embodiments described herein is 100 MHz.

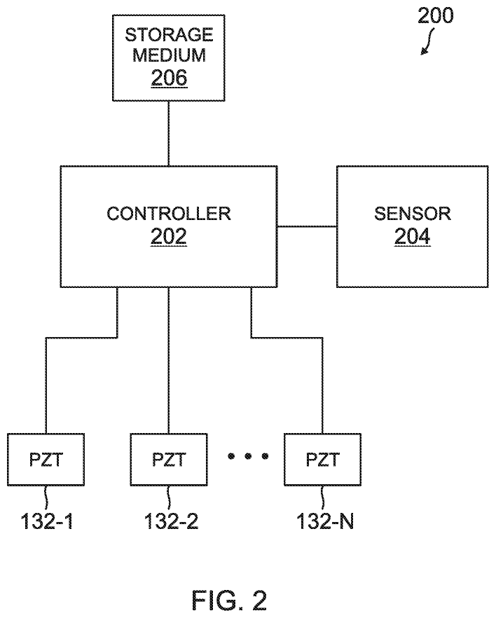

Referring to FIG. 2, an example of a repetition rate control system 200 of an example embodiment is illustrated. This example includes a controller 202 that is in communication with a sensor 204. Sensor 204 sensor is configured and positioned to sense the current repetition rate of the laser 100. If the repetition rate drifts from a desired repetition rate, the controller 202 adjusts one or more of the PZTs 132-1 through 132-n until the desired repetition rate is once again obtained. In one embodiment this is done by applying a select voltage signal (control signal) to the PZTs 132-1 to 132-n.

In general, the controller 202 may include any one or more of a processor, microprocessor, a digital signal processor (DSP), an application specific integrated circuit (ASIC), a field program gate array (FPGA), or equivalent discrete or integrated logic circuitry. In some example embodiments, controller 202 may include multiple components, such as any combination of one or more microprocessors, one or more controllers, one or more DSPs, one or more ASICs, one or more FPGAs, as well as other discrete or integrated logic circuitry. The functions attributed to the controller 202 herein may be embodied as software, firmware, hardware or any combination thereof. The controller 202 may be part of a system controller or a component controller. Any such software or firmware can comprise program instructions that are stored (or otherwise embodied) on or in an appropriate non-transitory storage medium or media 206 from which at least a portion of the program instructions are read by the associated processor or other programmable device for execution thereby.

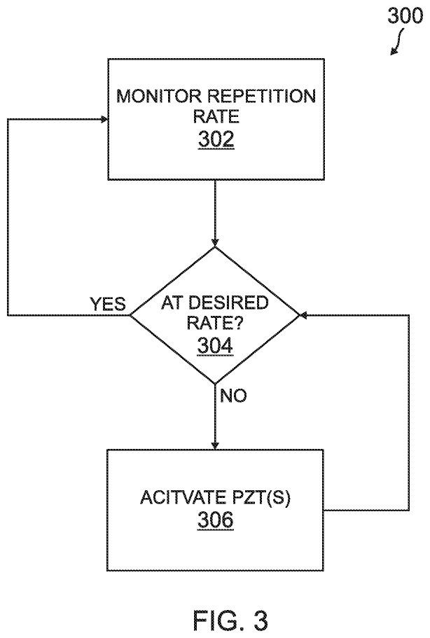

An example, of a repetition rate control flow diagram 300 implemented by controller 202 is illustrated in FIG. 3. The flow diagram is provide as a series of sequential blocks. The sequence may be different in other example embodiments. Hence, embodiments are not limited to the sequence of blocks set out in FIG. 3. As illustrated in FIG. 3, in this example, monitoring of the repetition rate of the laser 100 is conducted at block (302). In one example, the monitoring is provided by sensor signals generated by sensor 204 that senses the output 160 of the laser 100. If it is determined at block (304) that the repetition rate is at a desired repetition rate, the process continues at block (302) monitoring the repetition rate. If it is determined at block (304) that the repetition rate is not at a desired repetition rate, the process continues at block (306) by activating one or more PZTs to adjust the length of the hollow core fiber 130. This occurs until the desired repetition rate is achieved at block (304).

In at least some embodiments, the gain element 112 is in close contact with heat sinks so that the temperature of the gain element remains stable. In one embodiment, the heat sinks include the dichroic mirror 110 and the first gradient index mirror 106 as illustrated in FIG. 1. In this embodiment, the dichroic mirror 110 and the first gradient index lens 106 are made of good thermal conductive material and are in close contact with the gain element 112 to act as heat sinks for the gain element 112. For example, the dichroic mirror 110 and the first gradient index lens 106 may be made from optical material such as quartz, sapphire, diamond, etc., that have high thermal conductivity.

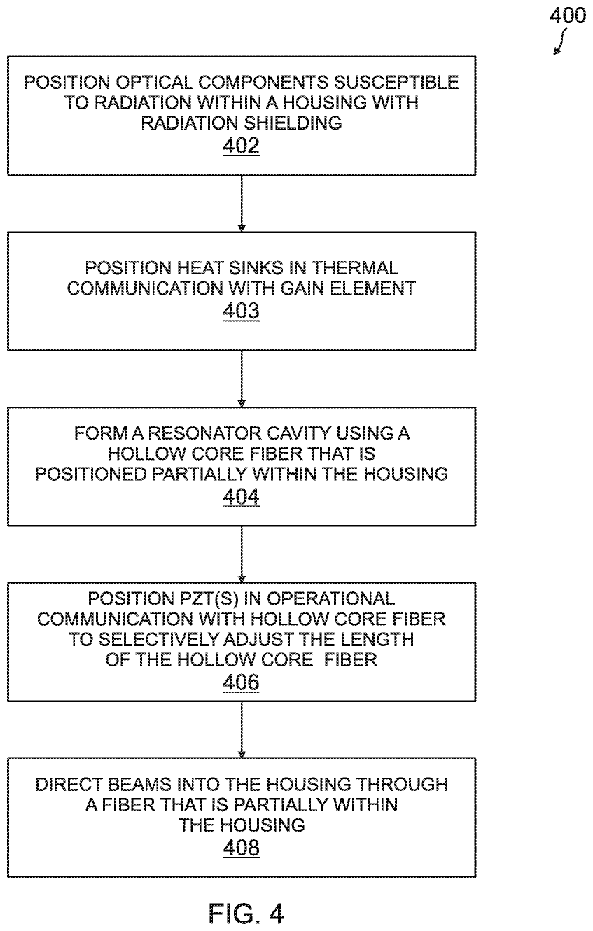

An example of a laser forming flow diagram of an example embodiment is illustrated in FIG. 4. The laser forming flow diagram is provided a in a series of sequential blocks. The sequence may be in a different order and may include more or different blocks in other embodiments. Hence embodiments are not limited to the sequence of blocks set out in FIG. 4.

In the example embodiment of FIG. 4, the process starts by placing optical components that are susceptible to radiation in a housing 102 that includes a radiation shield 104 at block (402). Those radiation sensitive optical components may include the gain element 112, the GRIN lenses 108 and 106, polarizer 114 and mirrors 116 and 110. Heat sinks are positioned to be in thermal communication with the gain element 112 within the housing 102 at block (403). In one embodiment the dichroic mirror 110 and lens 106 act as the heat sinks.

A resonator cavity is formed with use of a hollow core fiber that is partially positioned within the housing at block (404). As discussed above, resonant cavity of the laser between the saturable absorber mirror 116 and the output coupling mirror 140 uses the hollow core fiber 130 in the beam path through the resonator cavity.

The PZT(s) 132 are positioned in operational communication with the hollow core fiber to selectively adjust the length of the hollow core fiber 130 at block (406). An adjustment of the hollow core fiber 130 adjusts the length of resonant cavity. Adjustments in the length of the resonator cavity in turn adjusts the repetition rate of the laser 100. For example, the PZT(s) 132 may stretches the hollow core fiber to makes its length longer. This causes the pulse repetition rate to be reduced. A fiber is positioned to direct light beams from the pump laser input port 122 into the resonant cavity at block (408). This is done in an embodiment with the use of a fiber that is partially positioned within the housing 102.

### Example Embodiments

Example 1 includes a micro femtosecond laser with reduced radiation and temperature sensitivity. The laser includes a housing, a pair of spaced gradient index lenses, a dichroic mirror, a micro gain element, a polarizer, a semiconductor saturable absorber mirror, a pump light delivering fiber, a hollow core fiber and a partially reflective output coupling mirror. The housing includes a radiation shield and forms a stable mechanical support. The pair of spaced gradient index lenses are received within the housing. The dichroic mirror is received within the housing and is positioned between the pair of spaced gradient index lenses. The micro gain element is received within the housing and is positioned between the dichroic mirror and a first one of the gradient index lenses. The polarizer is received within the housing and is poisoned between the dichroic mirror and a second one of the gradient index lenses. The semiconductor saturable absorber mirror is also received within the housing and is positioned to reflect light beams to the second one of the gradient index lenses. The pump light delivering fiber has an input end and an output end. The input end of the pump light delivering fiber is positioned outside the housing. The output end of the pump light delivering fiber is positioned within the housing to deliver input beams to one of the gradient index lenses. The hollow core fiber has a first end and second end. The first end of the hollow core fiber is positioned within the housing to optically communicate the light beams to the first one of the gradient index lenses. The second end of the hollow core fiber is positioned outside the housing. The partially reflective output coupling mirror in optical communication with the second end of the hollow core fiber. The output coupling mirror and the saturable absorber form, in part, a laser resonator.

Example 2, includes the laser of Example 1, wherein, the housing has a first end and second end. The semiconductor saturable absorber mirror is positioned proximate the first end of the cavity. The pump light delivering fiber extends into the housing from the second end of the housing and the hollow core fiber extends into the housing from the second end of the housing.

Example 3 includes the laser of any of the Examples 1-2, wherein the gain element is in thermal contact with heat sinks so that its temperature remains stable.

Example 4 includes the laser of any of the Examples 1-3, wherein the dichroic mirror and the first gradient index lens are made of thermal conductive material and are in thermal contact with the gain element to act as heat sinks for the gain element.

Example 5 includes the laser of any of the Examples 1-4, further including at least one piezoelectric transducer in mechanical contact with the hollow core fiber to selectively change the fiber length with applied voltage.

Example 6 includes the laser of Example 5, further including, at least one sensor to sense a repetition rate of the laser and a controller in communication with the at least one sensor. The controller configured to activate the at least one piezoelectric transducer to selectively adjust the length of the hollow core fiber to selectively adjust the repetition rate of the laser.

Example 7 includes the laser of Example 6, wherein the controller is configured to maintain the repetition rate of the laser at a desired repetition rate by selectively activating the at least one piezoelectric transducer based on signals from the at least one sensor.

Example 8 includes the laser of any of the Examples 1-7, further including a pair of optical connectors configured to optically couple the second end of the hollow core fiber to laser output.

Example 9 includes a micro femtosecond laser with reduced radiation and temperature sensitivity. The laser includes a housing, optical components, a pump light delivering fiber, a hollow core fiber, a partially reflective output coupling mirror and a light signal generating pump. The housing includes a radiation shield. The optical components include a micro gain element and are received within the housing. The pump light delivering fiber has an input end and an output end. The input end of the pump light delivering fiber is positioned outside the housing. The output end of the pump light delivering fiber is positioned within the housing to deliver input beams to the optical components. The light signal generating pump is used to generate the input beams that are communicated to the input end of the pump light delivering fiber. The hollow core fiber has a first end and second end. The first end of the hollow core fiber is positioned within the housing to be in optical communication with the optical components. The second end of the hollow core fiber is positioned outside the housing. The partially reflective output coupling mirror is positioned to be in optical communication with the second end of the hollow core fiber.

Example 10 includes the laser of Example 9, wherein the optical components include a pair of spaced gradient index lenses, a dichroic mirror, polarizer and a saturable absorber mirror. The dichroic mirror is positioned between the pair of spaced gradient index lenses. The polarizer is poisoned between the dichroic mirror and a second one of the gradient index lenses. The saturable absorber mirror is positioned to reflect light beams to the second one of the gradient index lenses. Further, the micro gain element is positioned between the dichroic mirror and a first one of the gradient index lenses.

Example 11 includes the laser of Example 10, wherein he output end of the pump light delivering fiber is positioned to deliver the input beams to one of the pair of gradient index lenses.

Example 12 includes the laser of any of the Examples 10-11, wherein the first end of the hollow core fiber is positioned to be in optical communication with the one of the pair gradient index lenses.

Examples 13 includes the laser of any of the Examples 10-12, wherein a laser resonator is formed between the output coupling mirror and the saturable absorber mirror.

Example 14 includes the laser of any Examples 10-13, wherein the gain element is in thermal communication with at least one heat sink so that its temperature remains stable.

Examples 15 includes the laser of Example 14, wherein the at least one heat sink includes the dichroic mirror and the one of the pair of gradient index lens.

Example 16 includes the laser of any of the Examples 9-15, further including at least one piezoelectric transducer in operational communication with the hollow core fiber.

Example 17 includes the laser of Example 16, further including at least one sensor to sense a repetition rate of the laser and a controller in communication with the at least one sensor. The controller is configured to activate the at least one piezoelectric transducer to selectively adjust the length of the hollow core fiber to selectively adjust a repetition rate of the laser.

Example 18 includes a method of forming a micro femtosecond laser with reduced radiation and temperature sensitivity. The method includes positioning optical components that are susceptible to radiation including a gain medium within a housing that has radiation shielding; using a hollow core fiber that is positioned partially within the housing to form a resonator cavity with the optical components and a partially reflective output coupling mirror; and using a pump light delivering fiber that is positioned partially within the housing to deliver input beams to the optical components.

Example 19 includes the method of Example 18, further including placing at least one piezoelectric transducer in operational communication with the hallow core fiber to selectively adjust the length of the hollow core fiber.

Example 20 includes the method of any of the Examples 18-19, further including positioning at least one heat sink to be thermally communication with the gain element within the housing.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A micro femtosecond laser with reduced radiation and temperature sensitivity, the laser comprising:
a housing including a radiation shield, the housing forming a stable mechanical support;
a pair of spaced gradient index lenses received within the housing;
a dichroic mirror received within the housing and positioned between the pair of spaced gradient index lenses;
a micro gain element received within the housing and positioned between the dichroic mirror and a first one of the gradient index lenses;
a polarizer received within the housing and poisoned between the dichroic mirror and a second one of the gradient index lenses;
a semiconductor saturable absorber mirror received within the housing and positioned to reflect light beams to the second one of the gradient index lenses;
a pump light delivering fiber having an input end and an output end, the input end of the pump light delivering fiber positioned outside the housing, the output end of the pump light delivering fiber positioned within the housing to deliver input beams to one of the gradient index lenses;
a hollow core fiber having a first end and second end, the first end of the hollow core fiber positioned within the housing to optically communicate the light beams to the first one of the gradient index lenses, the second end of the hollow core fiber positioned outside the housing; and
a partially reflective output coupling mirror in optical communication with the second end of the hollow core fiber, the output coupling mirror and the saturable absorber forming in part a laser resonator.

2. The laser of claim 1, wherein,
the housing having a first end and second end;
the semiconductor saturable absorber mirror positioned proximate the first end of the cavity;
the pump light delivering fiber extending into the housing from the second end of the housing; and
the hollow core fiber extending into the housing from the second end of the housing.

3. The laser of claim 1, wherein the gain element is in thermal contact with heat sinks so that its temperature remains stable.

4. The laser of claim 1, wherein the dichroic mirror and the first gradient index lens are made of thermal conductive material and are in thermal contact with the gain element to act as heat sinks for the gain element.

5. The laser of claim 1, further comprising:
at least one piezoelectric transducer in mechanical contact with the hollow core fiber to selectively change the fiber length with applied voltage.

6. The laser of claim 5, further comprising:
at least one sensor to sense a repetition rate of the laser; and
a controller in communication with the at least one sensor, the controller configured to activate the at least one piezoelectric transducer to selectively adjust the length of the hollow core fiber to selectively adjust the repetition rate of the laser.

7. The laser of claim 6, wherein the controller is configured to maintain the repetition rate of the laser at a desired repetition rate by selectively activating the at least one piezoelectric transducer based on signals from the at least one sensor.

8. The laser of claim 1, further comprising:
a pair of optical connectors configured to optically couple the second end of the hollow core fiber to laser output.

9. A micro femtosecond laser with reduced radiation and temperature sensitivity, the laser comprising:
a housing including a radiation shield;
optical components including a micro gain element received within the housing;
a pump light delivering fiber having an input end and an output end, the input end of the pump light delivering fiber positioned outside the housing, the output end of the pump light delivering fiber positioned within the housing to deliver input beams to the optical components;
a light signal generating pump generating input beams that are communicated to the input end of the pump light delivering fiber;
a hollow core fiber having a first end and second end, the first end of the hollow core fiber positioned within the housing to be in optical communication with the optical components, the second end of the hollow core fiber positioned outside the housing; and
a partially reflective output coupling mirror positioned to be in optical communication with the second end of the hollow core fiber.

10. The laser of claim 9, wherein the optical components comprising:
a pair of spaced gradient index lenses;
a dichroic mirror positioned between the pair of spaced gradient index lenses;
a polarizer poisoned between the dichroic mirror and a second one of the gradient index lenses;
a saturable absorber mirror positioned to reflect light beams to the second one of the gradient index lenses; and
the micro gain element being positioned between the dichroic mirror and a first one of the gradient index lenses.

11. The laser of claim 10, wherein he output end of the pump light delivering fiber is positioned to deliver the input beams to one of the pair of gradient index lenses.

12. The laser of claim 10, wherein the first end of the hollow core fiber is positioned to be in optical communication with the one of the pair gradient index lenses.

13. The laser of claim 10, wherein a laser resonator is formed between the output coupling mirror and the saturable absorber mirror.

14. The laser of claim 10, wherein the gain element is in thermal communication with at least one heat sink so that its temperature remains stable.

15. The laser of claim 14, wherein the at least one heat sink includes the dichroic mirror and the one of the pair of gradient index lens.

16. The laser of claim 9, further comprising:
at least one piezoelectric transducer in operational communication with the hollow core fiber.

17. The laser of claim 16, further comprising:
at least one sensor to sense a repetition rate of the laser; and
a controller in communication with the at least one sensor, the controller configured to activate the at least one piezoelectric transducer to selectively adjust the length of the hollow core fiber to selectively adjust a repetition rate of the laser.

18. A method of forming a micro femtosecond laser with reduced radiation and temperature sensitivity, the method comprising:
positioning optical components that are susceptible to radiation including a gain medium within a housing that has radiation shielding;
using a hollow core fiber that is positioned partially within the housing to form a resonator cavity with the optical components and a partially reflective output coupling mirror; and
using a pump light delivering fiber that is positioned partially within the housing to deliver input beams to the optical components.

19. The method of claim 18, further comprising:
placing at least one piezoelectric transducer in operational communication with the hallow core fiber to selectively adjust the length of the hollow core fiber.

20. The method of claim 18, further comprising:
positioning at least one heat sink to be thermally communication with the gain element within the housing.
